(19) United States
(12) Patent Application Publication
(10) Pub. No.: US 2021/0319517 A1
(43) Pub. Date: Oct. 14, 2021

(54) SYSTEM AND METHOD FOR REMOTELY OBTAINING AN ELECTRONIC SIGNATURE

(71) Applicant: STATE FARM MUTUAL AUTOMOBILE INSURANCE COMPANY, Bloomington, IL (US)

(72) Inventors: Brant E. Aringdale, Gilbert, AZ (US); Todd S. Wiese, Bloomington, IL (US); Stephen W. Lauritson, Bloomington, IL (US); Holly B. Fuelling, Clemmons, NC (US); Amy L. Shreves, Le Roy, IL (US); Joseph Scott Slaughter, Bloomington, IL (US); Michael J. Heffron, El Paso, IL (US); Jason Jerdee, Bloomington, IL (US); Julie A. Jarrett, Normal, IL (US)

(21) Appl. No.: 15/042,392

(22) Filed: Feb. 12, 2016

Related U.S. Application Data
(60) Provisional application No. 62/117,028, filed on Feb. 17, 2015.

(51) Int. Cl. G06Q 40/08; G06F 17/24; G06F 3/0484; G06F 3/0482

(52) U.S. Cl. CPC G06Q 40/08; G06F 17/248; G06F 3/0482; G06F 17/243; G06F 3/04842

(57) ABSTRACT

A computer-implemented method for remotely obtaining signatures for insurance-related documents is presented. An insurance provider user interface creates a first insurance-related digital document from customer-associated data for a customer. The user interface generates and transmits a data request for an electronic signature to a first communication channel for the customer, and transmits the customer-associated data to a third party server. The third party is an electronic signature service that creates a second insurance-related digital document with the customer-associated data, electronically authenticates the customer and facilitates an electronic exchange of the second insurance-related digital document between insurance provider and customer. The user interface receives the second insurance-related digital document with a digital signature of the customer from the third party server. Additionally or alternatively, unique access codes may enhance security during data transmission, and/or upon receipt of electronically signed documents, insurance policies, premiums, discounts, rates, deductibles, coverages, etc. may be adjusted.

### CROSS-REFERENCE TO RELATED APPLICATION

This claims the benefit of U.S. Provisional Patent Application No. 62/117,028, entitled “System and Method for Remotely Obtaining an Electronic Signature” and filed on Feb. 17, 2015, the disclosure of which is hereby incorporated herein by reference in their entireties.

### FIELD OF THE INVENTION

The present disclosure generally relates to a system and method for remotely obtaining an electronic signature for a digital insurance-related document.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Most current business applications do not permit a customer to electronically sign a document in order to fully complete a transaction in either online/mobile or call-in communication channels. Within the insurance and financial industries, there is a large number of forms that require a customer's signature. With conventional methods, an agent or representative of a company offering an insurance product and/or financial product would have to send hardcopies of the forms to the customer for a “wet” signature, and wait for the customer to return the signed form via mail or facsimile. Alternatively, the customer would have to come to the agent's office to sign the forms. In either case, this often involved delays between the time the form was created and the time the document was signed and/or received by the agent. In the interim, the cost of the product could go up, or coverage may have been lost. Furthermore, even if the signed form was timely received, the signed form was scanned and stored, which required additional computing resources to scan the documents and maintain the images.

Third party vendors are available which provide electronic signature services. Such third party vendors authenticate parties, have the parties electronically sign digital documents, and facilitate the electronic exchange of the digital documents between two parties. An example of such a third party vendor is the San Francisco- and Seattle-based company DocuSign®. Generally, individual users of these third party vendors must create an account and/or login credentials and utilize the user interface provided by the third party vendor.

However, utilizing a third party vender and its user interface requires personnel of the company to have individual logins, as well as learn how to utilize the various functions of the tool. This may require a great deal of time and computing resources in order to setup and maintain the database of users, maintain workflow, facilitate interactions with the third party vendor, etc. Further, changes in third party vendors may cause problems for company personnel with new login credentials, training, etc., and/or require additional computing resources to facilitate such changes on an enterprise level.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In one aspect, a computer-implemented method remotely obtaining a signature for an insurance-related document may be provided. The method may include (1) receiving, by a first party user interface, customer-associated data for a second party customer; (2) creating, by the first party user interface, a first insurance-related digital document from the received customer-associated data; (3) generating and transmitting, by the first party user interface in response to the creation of the first insurance-related digital document, a data request for a signature to a second party customer communication medium; (4) transmitting, by the first party user interface in response to the creation of the first insurance-related digital document, the customer-associated data to a third party server, wherein the third party is an electronic signature service that creates a second insurance-related digital document with the customer-associated data, electronically authenticates the second party and facilitates an electronic exchange of the second insurance-related digital document between the first party and second party; and/or (5) receiving, by the first party user interface, the second insurance-related digital document with a digital signature of the second party customer from the third party server to facilitate obtaining electronic signatures of customers on insurance-related and/or other documents. Further, unique access codes may enhance security during data transmission, and/or upon receipt of electronically signed documents from the customer, insurance policies, premiums, discounts, etc. may be updated or generated. The method may include additional, less, or alternate functionality, including that discussed elsewhere herein.

In another aspect, a computer system for remotely obtaining a signature for an insurance-related document may be provided. The system may include (i) one or more processors; and/or (ii) one or more memories coupled to the one or more processors. The one or more memories may include non-transitory computer executable instructions stored therein. The instructions, when executed by the one or more processors, may cause the one or more processors to: (1) receive customer-associated data for a second party customer; (2) create a first insurance-related digital document from the received customer-associated data; (3) generate and transmit, in response to the creation of the first insurance-related digital document, a data request for a signature to a second party customer communication medium; (4) transmit, in response to the creation of the first insurance-related digital document, the customer-associated data to a third party server, wherein the third party is an electronic signature service that creates a second insurance-related digital document with the customer-associated data, electronically authenticates the second party and facilitates an electronic exchange of the second insurance-related digital document between the first party and second party; and/or (5) receive the second insurance-related digital document with a digital signature of the second party customer from the third party server to facilitate obtaining electronic signatures of customers on insurance, financial, and/or other documents. Further, unique access codes may enhance security during data transmission, and/or upon receipt of electronically signed documents, insurance policies, premiums, discounts, etc. may be updated or generated. The system may include additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

There are shown in the drawings arrangements which are presently discussed, it being understood, however, that the present aspects are not limited to the precise arrangements and instrumentalities shown, wherein:

FIG. 1 is a block diagram of an exemplary architecture for implementing a system 100 for remotely obtaining an electronic signature;

FIG. 2 is a block diagram of an exemplary network showing exemplary communications and/or interactions between the first party company, second party customer and third party electronic signature service;

FIG. 3 is a flowchart of an exemplary method, routine or process for remotely obtaining a signature from the second party customer for a digital insurance-related document;

FIGS. 4-6 are exemplary graphical user interfaces and related functionality of an example document creation page;

FIG. 7 is an exemplary graphical user interface and related functionality of an example status dashboard;

FIG. 8 is a flowchart of an exemplary method, routine or process for reviewing and electronically signing a digital insurance-related document;

FIGS. 9-13 are exemplary graphical user interfaces and related functionality on the second party customer side of reviewing and electronically signing the digital insurance-related document;

FIG. 14 is a flowchart of an exemplary method, routine or process for facilitating the electronic signature of a digital insurance-related document; and

FIG. 15 is an exemplary architecture of a data system.

The Figures depict a preferred embodiment of the present invention for purposes of illustration only. One of ordinary skill in the art will readily recognize from the following discussion that alternative embodiments of the structures and methods illustrated herein may be employed without departing from the principles of the invention described herein.

### DETAILED DESCRIPTION

The present embodiments relate to, inter alia, providing a method for remotely obtaining a signature for an insurance and/or financial-related documents and/or other suitable products and/or services. A means may be provided for customers to electronically sign documents in order to fully complete a transaction (such as either in the online/mobile or call-in communication channels), which may be an efficient, time saving, and responsive alternate to conventional techniques.

The present embodiments may (1) provide an alternative solution to customers who are unable and/or forget to return signed paper forms; (2) enhance the customer experience through positive interaction by providing an improved response by obtaining signatures on electronic forms; (3) potentially improve voluntary lapse/cancellation ratio, particularly through retention of customers who may be negatively impacted by the absence of signed forms on file (which may lead to customer dissatisfaction and inconvenience, and/or shopping elsewhere); (4) expedite the turnaround time of the forms; and/or (5) reduce the amount of paper follow-up for missing forms.

The tool or user interface provided herein may allow for quickly mitigating various issues as compared to sending forms through postal mail or requiring customer to physically come into an office to sign paper forms. The user interface may be used with new business (such as with new insurance or financial services customers), updating policies and forms with existing business (such as making changes to coverages, limits, deductibles, etc. for insurance customers), and/or renewing insurance policies (such as every 6 months or other time frames).

The present embodiments may also include a user interface that creates a continuous enterprise level solution that provides separation from a vendor solution and an agnostic solution. For instance, a unique user interface (distinct from any vendor user interface) may provide separation from a vendor solution related to electronic signatures. As a result, the user interface may present a consistent enterprise-related “look and feel” to users, while also enhancing security of sensitive or personal information.

Utilizing the user interface may eliminate the need for agents or call center representatives to have individual logins, and access may be controller via LDAP groups. The user interface may only contain the functionality needed to execute the required tasks.

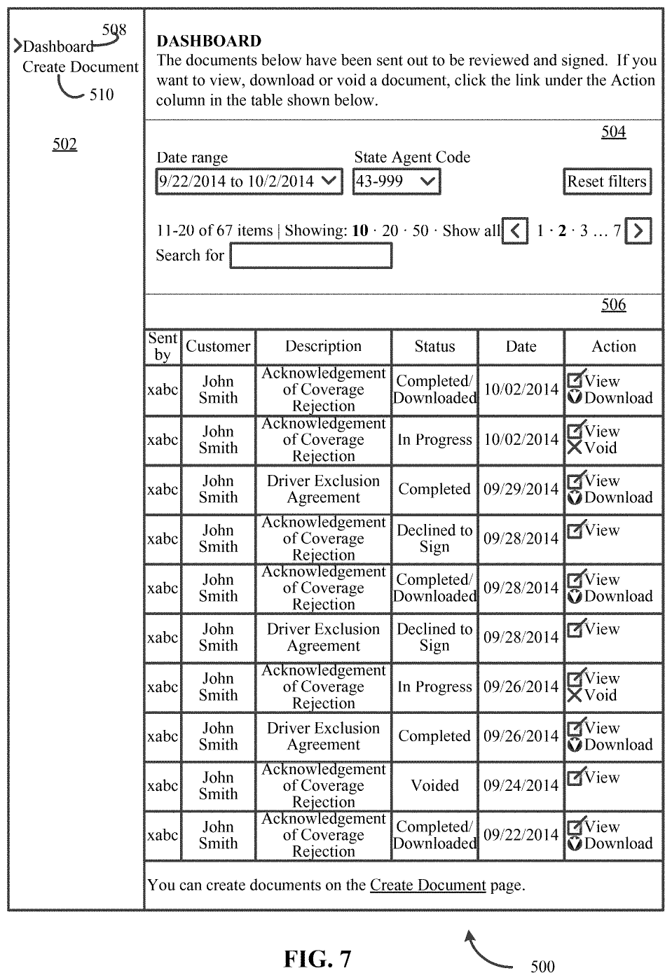

The unique user interface may allow an end user to send/receive documents for an electronic signature, as well as view a dashboard to track the status of documents. The dashboard may display a summary of customer information to agents and/or call center representatives. The dashboard may also display a listing of documents that have been electronic sent out to customers for their review and electronic signature. The user interface may allow the user (such as an agent, or even a customer) to view, download, or void a document, such as by clicking a link in an Action column (such as depicted in FIG. 7).

With respect to FIG. 7, the user interface may present a workflow and/or documents for an agent or call center representative to track, such as with a book of business. This may be important in the case that there is only a limited amount of time for a customer or potential customer to sign and return certain forms, and/or review various notices. The review or summary dashboard may allow an agent or call representative to view the status of several document packages, and/or the actions that may be taken for each. The user interface may enable the agent or call representative to download completed and signed documents (including certificates of completion). A status for each document may be presented on the user interface, such as “Completed,” “Declined to Sign,” “In Progress,” “Error,” etc.

### I. EXEMPLARY USER INTERFACE AND RELATED FUNCTIONALITY

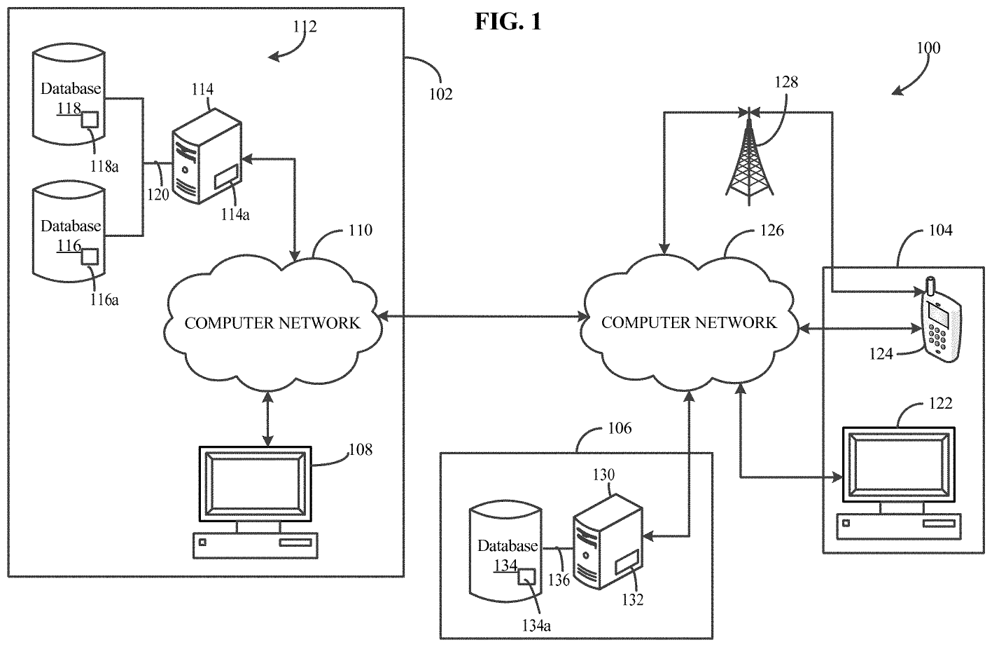

FIG. 1 illustrates various aspects of an exemplary architecture for implementing a system 100 for remotely obtaining an electronic signature. The high-level architecture may include both hardware and software applications, as well as various data communications channels for communicating data between the various hardware and software components. The system 100 for remotely obtaining an electronic signature may include various software and hardware components or modules that may employ a method to create an insurance-related document, request an electronic signature from a second party customer, obtain the electronic signature from the second party customer via a third party electronic signature service, receive the signed insurance-related document from the third party electronic signature service and monitor the status of the document throughout the process. The various modules may be implemented as computer-readable storage memories containing computer-readable instructions (i.e., software) for execution by a processor of the system 100 for obtaining an electronic signature.

Generally speaking, the first party corresponds to a company and/or service provider, such as a business offering one or more insurance and/or financial product lines to customers, including, but not limited to, auto insurance, home insurance, life insurance, renters insurance, various loans, such as vehicle, home, and/or personal loans, bank, mutual funds, annuities, financial products, etc. The second party corresponds to a customer of the company, such as a holder of an insurance policy of the company, a beneficiary of a policy, a claimant, etc. The third party corresponds to a company that offers an electronic signature service which authenticates the second party and facilitates an electronic exchange of documents between the first party company and the second party customer. An example of a third party electronic signature service is DocuSign®.

A. Exemplary First Party Components

The system 100 for obtaining an electronic signature may include a first party system 102, a second party system 104, and/or a third party system 106. The first party system may include both front end and back end components for a first party company.

i. Exemplary Front End Components

The first party system 102 may include front end components, including a computing device 108 that may execute instructions for performing a quote application process, accessing a standard status of a product, etc. The computing device 108 may include a personal computer, smart phone, tablet computer, or other suitable computing or mobile device. Those skilled in the art will recognize that the present system may be used in a dedicated application, a web browser, a combination thereof, etc.

In some embodiments, the computing device 108 connects to a computer network 110, such as the Internet or other type of suitable network (e.g., local area network (LAN), a metropolitan area network (MAN), a wide area network (WAN), a mobile, a wired or wireless network, a private network, a virtual private network, etc.). The computing device 108 may connect to back end components 112 via the computer network 110. According to the present embodiment, a processor of the computing device 108 may execute instructions to transmit data to, receive data from, and/or otherwise communicate with back end components 112 via the computer network 110. As also disclosed herein, the processor of the computing device 108 may execute instructions to transmit data to, receive data from and/or otherwise communicate with components of the second party system 104 and/or third party system 106. The exemplary first party system shown in FIG. 1 may include additional, fewer, or alternate computing devices 108, including those discussed elsewhere herein.

ii. Exemplary Back End Components

The back end components 112 may include a server 114 that may include one or more computer-executable instructions 114a for presenting a common user interface for each of the computing devices 108 in order to obtain an electronic signature from a second party customer 104 using the third party electronic signature service. The back end components 112 may also include a database 116 that stores data 116a associated with a customer. The database 116 may also store other data, such as standard statuses, products associated with a customer account, etc. The customer database 116 may include a data storage device, such as random-access memory (RAM), hard disk drive (HDD), flash memory, flash memory such as a solid state drive (SSD), etc. The back end components 112 may further include one or more additional databases 118 for storing data 118a data associated with an insurance agent and/or insurance office for the first party company or some other employee or independent contractor affiliated with the first party company, such as access codes used to uniquely identify a representative of the company (e.g., an insurance agent), an office or other affiliate of the company or a book of business. The back end components may communicate with each other through a communication network 120, such as a local area network or other type of suitable network (e.g., the Internet, a metropolitan area network (MAN), a wide area network (WAN), a mobile, a wired or wireless network, a private network, a virtual private network, etc.).

B. Exemplary Second Party Components

The second party consumer system 104 may include a computing device 122 that may execute instructions for viewing and signing an electronic document, such as an insurance-related document and/or financial document for a product offered by a company. The computing device 122 may include a personal computer, mobile device, or other suitable computing device. The second party consumer system 104 may also include a communication device 124 that may transmit data to, receive data from and/or otherwise communicate with the first party system 102 and/or the third party system 104. Those skilled in the art will recognize that the present system may be used in a dedicated application, a web browser, a combination thereof, etc. The communication device 124 may include a personal computer (e.g., a communication application stored on and executed by the personal computer), a mobile device (e.g., smart phone, tablet computer, phablet, laptop, wearable electronics, smart watch or bracelet, smart glasses, pager, personal digital assistant (PDA), notebook, netbook, etc.), other suitable computing device, and/or other devices configured for wired or wireless communication and/or data transmission, such as via the internet or other communications network. In some embodiments, the computing device 122 and the communication device 124 are one and the same.

In some embodiments, the computing device 122 and/or the communication device 124 connects to a computer network 126, such as the Internet or other type of suitable network (e.g., local area network (LAN), a metropolitan area network (MAN), a wide area network (WAN), a mobile, a wired or wireless network, a private network, a virtual private network, etc.). In the case of a communication device 124, the communication device 124 may be able to connect to the computer network 126 via wireless local area network (e.g., WiFi) or through a mobile communication system 128 (e.g., cellular communication system). According to the present embodiment, a processor of the computing device 122 and a processor of the communication device 124 may each execute instructions to transmit data to, receive data from or otherwise communicate with components of the first party system 102 and/or third party system 104 via the computer network 126.

C. Exemplary Third Party Components

The third party system 106 may include a third party server 130 that may include one or more computer-executable instructions 132 for creating a second insurance-related electronic document using data from the first party system 102 and electronically authenticating the second party, facilitate an electronic signature from the second customer party in the second insurance-related document, and/or facilitate the exchange of the second insurance-related document between the first party company and the second party customer.

The third party system 106 may also include a database 134 that stores data 134a associated with the first party company and/or the second party customer. The database 134 may also store other data, such as document templates for documents associated with the first party company to create the second insurance-related document, image data of the second party customer's signature, etc. The customer database 134 may include a data storage device such as random-access memory (RAM), hard disk drive (HDD), flash memory, flash memory such as a solid state drive (SSD), etc. The components of the third party system 106 may communicate with each other through a communication network 136, such as a local area network or other type of suitable network (e.g., the Internet, a metropolitan area network (MAN), a wide area network (WAN), a mobile, a wired or wireless network, a private network, a virtual private network, etc.).

According to the present embodiment, a processor of the third party server 130 may execute instructions to transmit data to, receive data from or otherwise communicate with the components of the first party system 102 and/or the second party system 104. The exemplary third party system shown in FIG. 1 may include additional, fewer, or alternate computing devices, including those discussed elsewhere herein. In some embodiments, the third party server 130 connects to the computer network 126.

The exemplary system 100 shown in FIG. 1 may include additional, fewer, or alternate components, including those discussed elsewhere herein.

### II. EXEMPLARY NETWORK AND COMMUNICATIONS

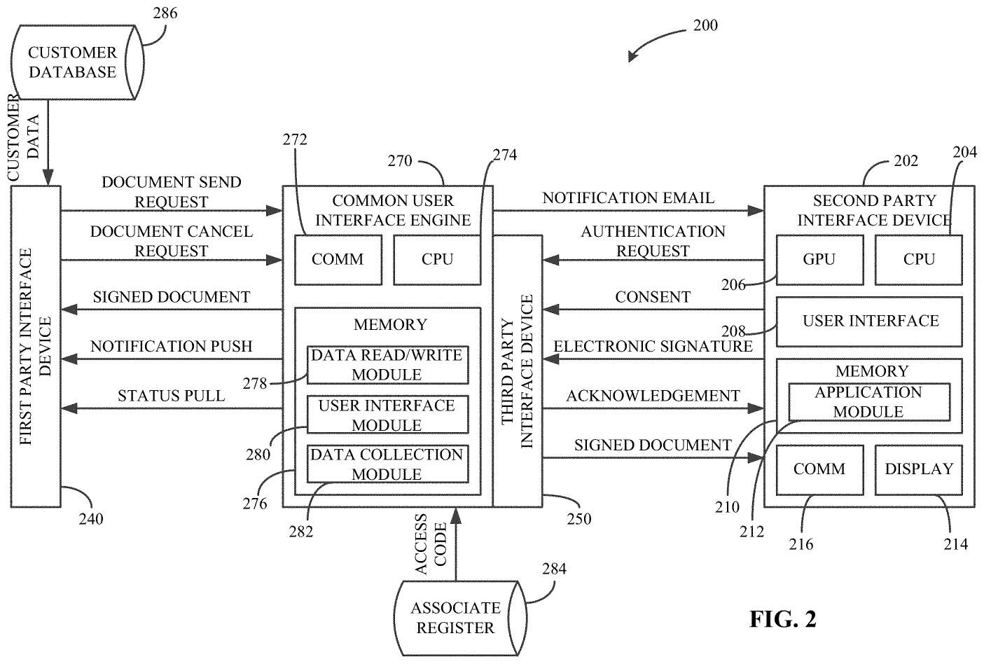

FIG. 2 is a block diagram of an exemplary network 200 showing exemplary communications and/or interactions between the first party company, second party customer and third party electronic signature service. The network 200 may include a second party customer interface device 202, a third party electronic signature service interface device 250, first party company interface device 240, and/or a common user interface engine 270. In the present aspect, the second party customer interface device 202 and third party electronic signature service interface device 250 may be implementations of the second party system 104 and third party system 106, respectively. The first party company interface device 240 and/or common user interface engine 270 may be implementations of the first party system 102. More specifically, the first party company interface device 240 may be an implementation of the computing device 108, and/or the common user interface engine 270 may be an implementation of the server 114 with computer-executable instructions 114a.

The second party customer interface device 202 may be configured to connect to third party electronic signature service interface device 250 via a network, such as the computer network 126 of FIG. 1. The second party customer interface device 202 may include a central processing unit (CPU) 204, a graphics processing unit (GPU) 206, a user interface 208, a memory 210, a display 214, and/or a communication unit 216. In the present aspect, the second party customer interface device 202 may be implemented as any suitable type of computing device, such as a UE, a mobile device, a computer, laptop, tablet, desktop, wearable electronic devices, etc. Further, in the present aspect, the computing device 122 and the communication device may have substantially similar structures, features, and functionality as the second party customer interface device 202. Therefore, only differences between these devices will be further described.

The CPU 204 and/or GPU 206 may be configured to communicate with the memory 210 to store to, and read data from, the memory 210. In accordance with the present aspects, the memory 210 may be a computer-readable non-transitory storage device that may include any combination of volatile (e.g., a random access memory (RAM), or a non-volatile memory (e.g., battery-backed RAM, FLASH, etc.)). The memory 210 may be configured to store instructions executable upon the CPU 204 and/or GPU 206. These instructions may include machine readable instructions that, when executed by the CPU 204 and/or GPU 206, cause the CPU 204 and/or GPU 206 to perform various acts.

The user interface 208 may be configured to allow a user to interact with the second party customer interface device 202. For example, the user interface 208 may include a user-input device, such as an interactive portion of display 214 (e.g., a “soft” keyboard displayed upon display 214), an external hardware keyboard configured to communicate with second party customer interface device 202 via a wired or a wireless connection (e.g., a BLUETOOTH keyboard), an external mouse, or any other suitable user-input device.

The communication unit 216 may be configured to enable data communications between the second party customer interface device 202 and the third party electronic signature service interface device 250, the common user interface device 270 and/or the first party company interface device 240. In the present aspect, the communication unit 216, and particularly the communication unit 216 of the computing device 122, may be configured to send data, which may include requests for authentication, consents, acknowledgements, and/or electronic signatures, entered by a customer via the user interface 208, to the third party electronic signature service interface device 250.

For example, the communication unit 216 may send a customer's authentication code to access a digital insurance-related document from the third party electronic signature service, consent to execute (e.g., sign) the digital insurance-related document, electronic signature for the digital insurance-related document and/or any other suitable relevant information used to review and sign the digital insurance-related document, to the third party electronic signature service interface device 250 via the network 126. Similarly, the communication unit 216, and particularly the communication unit 216 of the computing device 122, may be configured to receive data, such as insurance policy details, acknowledgements of receipt and digital copies of the signed-insurance-related document, from the third party electronic signature service interface device 250 via the network 126, as well as receive data, such as notifications to sign the insurance-related document, from the common user interface engine 270 via the network 126.

In the present aspect, the communication unit 216, and particularly the communication unit 216 of the communications device 124, may be configured to receive data from the third party electronic signature service interface device 250, such as an access code to access the digital insurance-related document from the third party electronic signature service interface device 250.

As will be appreciated by those of ordinary skill in the relevant art(s), the communication unit 216 may be implemented with any combination of suitable hardware and/or software to facilitate this functionality. For example, the communication unit 216 may be implemented with any number of wired and/or wireless transceivers, network interfaces, physical layers (PHY), etc. In aspects in which second party customer interface device 202 is a mobile device, the communication unit 216 may enable communications with one or more networks, which may or may not be part of network 126. For example, the communication unit 216 may be configured to communicate with cellular networks, such as the communications network 128, and/or WLAN networks in addition to network 126. Networks separate from networks 126, 128 are not shown in FIG. 1 for purposes of brevity.

The application module 212 may be a portion of memory 210 configured to store instructions, that when executed by CPU 204 and/or GPU 206, cause CPU 204 and/or GPU 206 to enable user interface 208 to collect user input and to display feedback to a user in accordance with one or more applications and/or programs. For example, executable instructions stored in the application module 212 may enable the user interface 208 to display one or more prompts to a user and/or to accept user input, which could include entering data into one or more data fields, for example. In the present aspect, instructions stored in the application module 212 may enable a user to review and electronically sign a digital insurance-related document, and provide consent to do the same.

The application module 212 may enable the user interface 208 to facilitate sending data to another device, such as the third party electronic signature service interface device 250, for example, via the communication unit 216. For example, the application module 212 may include instructions that enable the user interface 208 to collect relevant data from a customer and then allow the customer to submit the relevant data to the third party electronic signature service interface device 250 by clicking or pressing an appropriate interactive button. If a customer previously used another interface device, various aspects may include the application module 212 having instructions that enable the user interface 208 to prompt a user only for customer information that has not already been stored (i.e., entered by the customer).

In some of the present aspects, the application module 212 may include a full application that may be downloaded and/or installed upon second party customer interface device 202. In accordance with such aspects, the application module 212 may provide standalone application functionality, and may minimally utilize communications with the third party electronic signature service interface device 250 to access a digital insurance-related document and/or transmit an electronic signature to the third party electronic signature service interface device 250. As will be appreciated by those of ordinary skill in the relevant art(s), the present aspects of the application module 212 may be utilized based upon a particular implementation of the second party customer interface device 202.

Although FIG. 2 illustrates the second party customer interface device 202 communicating with a single the third party electronic signature service interface device 250 and/or common user interface engine 270, the present aspects may include a second party customer interface device 202 communicating with any suitable number of other application engines using any suitable number of networks.

In the present aspect, the first party company interface device 240 and third party electronic signature service interface device 250 may have substantially similar structure, features, and functionality as the second party customer interface device 202. Therefore, only differences between these devices will be further described.

In the present aspect, each first party company interface device 240 may implement respective application modules that provide identical, or substantially identical, application processes. For example, in the present aspect, each first party company interface device 240 may present a user, such as an authorized agent or representative of the first party company, with the same application interface in which to enter customer information, create a digital insurance-related document which may then be sent to the common user interface engine 270, cancel requests to have the second party customer electronically sign the digital insurance-related document, view the status of a digital insurance-related document, receive notification that a digital insurance-related document has been electronically signed by the second party customer, receive a digital insurance-related document electronically signed by the second party customer by each respective interface device via a corresponding channel.

In this way, a uniform application interface may be used for each interface device 240 regardless of who is entering or viewing the information. By providing a uniform application interface, interaction with third party electronic signature service does not require each agent or representative of the first party company to have a separate access code for the third party electronic signature service. Rather, the common user interface engine 270 may utilize a single (or minimal number of) access code(s) to interact with the third party electronic signature service interface device 250 and agents or representatives of the first party company may use existing access codes in order to interact with the common user interface engine 270.

This may provide a much more simplified interface between the first party company and the third party electronic signature service. Moreover, where the third party electronic signature service is a vendor independent of the first party company, the uniform application interface provides a vendor-agnostic technical solution for the first party company such that utilization of different electronic signature service vendors requires less technical overhaul when electronic signature service vendors are added or removed, as compared to providing each agent or representative with new access codes, user interfaces and associated technical training during such changes.

In the present aspect, the third party electronic signature service interaction device 250 may receive customer data from the common user interface engine 270 as provided from the first party company interface device 240, and create a second digital insurance-related document from the customer data using a template of the insurance-related document previously provided by the first party company, which may then be sent to the second party customer interface device 202, particularly the computing device 122. For example, where the common user interface engine 270 has provided notification to the second party customer interface device 202 that a digital insurance-related document is ready for the second party customer's review and signature, the third party electronic signature service interaction device 250 may receive an authentication request from the second party customer interface device 202, where the authentication request includes a request for an access code in order to access and view the second digital insurance-related document from the third party electronic signature service interaction device 250 via the second party customer interface device 202.

The third party electronic signature service interaction device 250 may transmit the access code to a separate second party customer interface device 202, such as the communication device 126, or otherwise transmit the access code to a second party customer interaction device 202 that is trusted to be access only and/or primary by the second party customer. Upon receipt of the access code and an indication of consent from the second party interface device 202, the third party electronic signature service interaction device 250 allows the second party interface device 202 access to the second digital insurance related-document.

Upon receipt of an electronic signature from the second party customer interface device 202, the third party electronic signature service interaction device 250 may provide the second party customer interface device 202 with an acknowledgement of receipt and a digital copy of the signed insurance-related document. Also upon receipt of an electronic signature from the second party interface device 202, the third party electronic signature service interaction device 250 may notify the common user interface engine 270 that the electronic signature has been received, and/or in response to a request to provide the signed insurance-related document, the third party electronic signature service interaction device 250 may upload a digital copy of the signed insurance-related document to the common user interface engine. During this process, the third party electronic signature service interaction device 250 may respond to status requests and/or otherwise provide a status regarding a digital insurance-related document, including, but not limited to, completed (indicating the second party customer has provided an electronic signature), in progress (indicating the digital insurance related document is pending review by the second party customer), declined to sign (indicating the second party customer did not consent to the electronic signature process), voided (indicating cancellation of the electronic signature process) and/or downloaded (indicating a digital copy of the signed insurance related document has been uploaded to the common user interface engine 270).

As will be appreciated by those of ordinary skill in the relevant art(s), subtle variations between application interfaces may be present without departing the spirit and scope of the present disclosure. For example, the third party electronic signature service interface device 250 and/or first party company interface device 240 may incorporate additional application interface features that are not implemented by the second party customer interface device 202. Likewise, the third party electronic signature service interface device 250 may incorporate additional application interface features that are not implemented by the first party company interface device 240, and the first party company interface device 240 may incorporate additional application interface features that are not implemented by the third party electronic signature service interface device 250.

To provide illustrative examples, the third party electronic signature service interface device 250 and/or first party company interface device 240 may implement additional features specific to collecting data from a customer. This may include entry of information to appropriately identify the customer, entry of a customer account, an insurer agent/representative secure login, etc.

In the present aspects, the common user interface engine 270 may be implemented as any suitable type of server, such as an application server, a database server, a standalone sever, a web-based server, and/or as any suitable type of computing device, such as a computer, a smartphone, a laptop, a cloud-based computing device, etc. In one embodiment, the common user interface engine 270 may be implemented as a backend component 112, such as the server 114 computer-executable instructions 114a.

In the present aspects, a communication unit 272 may be configured to enable data communications between the common user interface engine 270 and one or more of second party customer interface device 202, first party company interface device 240, and/or third party electronic signature service interface device 250 via networks 126, 128. Again, this data could include any suitable relevant customer information, for example, sent from one or more of second party customer interface device 202, first party company interface device 240, and/or third party electronic signature service interface device 250 via their respective channels, particularly with respect to facilitating an electronic signature of an insurance-related document.

In the present aspect, a CPU 274 may be configured to communicate with a memory 276 to store to and read data from the memory 276. In accordance with the present aspects, the memory 276 may be a computer-readable non-transitory storage device that may include any combination of volatile (e.g., a random access memory (RAM), or non-volatile memory (e.g., battery-backed RAM, FLASH, etc.). The memory 276 may be configured to store instructions executable by the CPU 274. These instructions may include machine readable instructions that, when executed by the CPU 274, cause the CPU 274 to perform various acts.

A data read/write module 278, a user interface module 280, and a data collection module 282 are portions of the memory 276 that may be configured to store instructions executable by the CPU 274. In the present aspect, the data read/write module 278 may include instructions that, when executed by the CPU 274, causes the CPU 274 to read data from and/or to write data to the first party company interface device 240. In the present aspect, the data read/write module 278 may enable the CPU 274 to access an associate register 284 to determine which agent or representative of the first party company is utilizing the common user interface engine 270.

In particular, the data read/write module 278 may enable the CPU 274 to associate an access code with a particular agent, representative, office or book of business for the first party company, such that a user of the first party company interface device is limited to creating, sending, obtaining signatures for, and viewing the status of digital insurance-related documents for particular second customers associated with that access code. In addition, the data read/write module 278 may embed the access code and/or an electronic tag associated with the access code with the customer data sent to the third party electronic signature service interface device 250, such that any insurance-related document generated by the third party electronic signature service interface device 250 and/or signed by the second party customer includes the access code and/or tag as metadata, which uniquely associates the insurance-related document and all information pertaining thereto with the access code.

In the present aspects, the data read/write module 278 may enable the CPU 274 to query data from a customer database 286, to store this data in memory 276 and/or to write this data to a digital insurance-related document. Further in accordance with this aspect, data read/write module 278 may include instructions that enable the CPU 274 to access stored data from the memory 276 when executing instructions from the user interface module 280 and/or the data collection module 282.

The data collection module 282 may include instructions that, when executed by the CPU 274, causes the CPU 274 to store and/or aggregate data, such as customer data, received via the first party company interface device. For example, if an agent or representative of the first party company creates a digital insurance-related document via the first party company interface device 240 and then finishes the signature process using the third party electronic signature service interface device 250, the data collection module 282 may include instructions that enable the CPU 274 to merge data collected from each of these interface devices into a completed and signed digital insurance-related document.

The user interface module 280 may include instructions that, when executed by the CPU 274, may cause the communications module 272 to communicate or otherwise provide a common user interface to the first party company interface device 240. In one embodiment, the common user interface has the same functionality, look and feel for each first party company interface device 240, which may include having some or all of the same functionality, look and feel of a user interface on the first party company interface device 240. The common user interface may be provided as a web browser, an application programming interface (API), etc. invokable by an application module on the first party company interface device 240.

In accordance with the present aspects, any of the data read/write module 278, user interface module 280, and data collection module 282 may operate as a separately executable software application, a plugin that extends the functionality of another software application such as a web browser, an application programming interface (API) invokable by a software application, etc. The instructions included within any of the data read/write module 278, user interface module 280, and/or data collection module 282 may be compiled and executable on their respective CPUs directly, or not compiled and interpreted by their respective CPUs on a runtime basis.

Although illustrated as a single engine in FIG. 2, in the present aspects, the common user interface engine 270 may be implemented with any number or group of application engines. In accordance with such aspects, each application engine may include one or more CPUs and be configured to operate independently of the other application engines. Application engines operating as a group may process requests from any suitable number of first party company interface devices individually (e.g., based upon their availability) and/or concurrently (e.g., parallel processing). Application engines operating as a group may process data received from one or more first party company interface devices in a prioritized and/or distributed manner. For example, an operation associated with processing a request may be performed on one application engine while another operation associated with processing the same request (or a different request) is performed on another application engine.

### III. Exemplary Flowchart for Remotely Obtaining an Electronic Signature

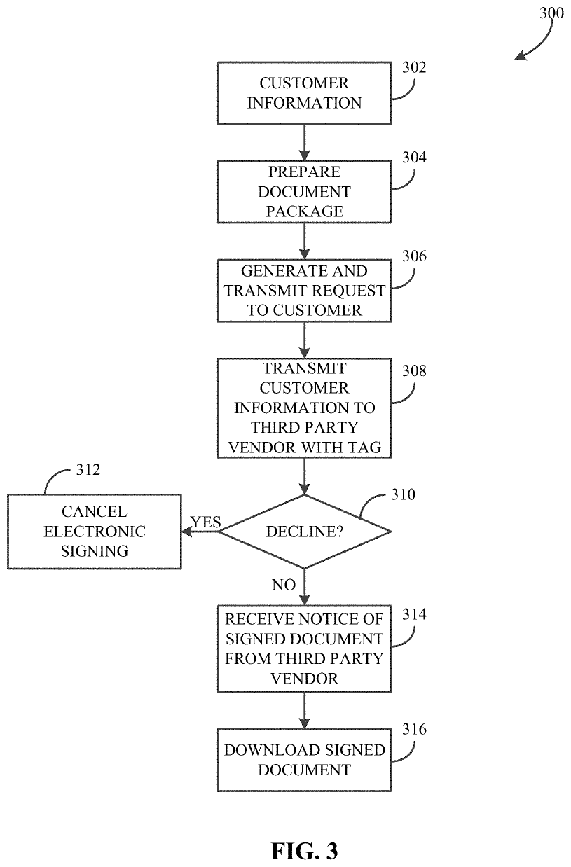

FIG. 3 is a high level flowchart of an exemplary method, routine or process 300 for remotely obtaining a signature from the second party customer for a digital insurance-related document. A user, such an insurance agent or representative associated with the first party company or some other employee or independent contractor affiliated with the first party company, may use a first party company interface device 240, such as the computing device 108 illustrated in FIG. 1, to access a company program. The company program may be a website hosted on one or more servers, such as the server 114, described in reference to FIG. 1.

In particular, the user may access a user interface program of the user interface module 280 in the common user interface engine 274 in order to create a digital insurance-related document, and obtain an electronic signature from the second party customer for the digital insurance-related document. As such, in one aspect, method 300 may be implemented by a common application engine, such as common user interface engine 270, for example, as shown in FIG. 2.

The method 300 may begin when the user enters an input, via a mouse click, touch press, keyboard click, etc., representing a selection of an option to create a digital insurance-related document for the second party customer's electronic signature. The selection of this option may include entering an access code, such as a state agent code, which uniquely identifies the user, the user's office, or the user's and/or office's book of business (e.g., those insurance policies and/or customers associated with the user and/or the user's office). The selection of this option may also include a selection of an insurance-related document.

In the exemplary method and user interface described below, these insurance-related documents are disclosed as an “acknowledgement of coverage rejection form” and a “driver exclusion agreement”. However, those of ordinary skill in the art will readily recognize that the documents may be any insurance-related document and/or financial-related document that may require a second party customer's review and signature.

In some embodiments, the server may also execute an instruction to verify the credentials via the use of a password or other verification technique, for example by comparing the entered access code with the access codes in the associate register 284. In any event, when the access code and/or document selection is received by the server, a processor of the server may execute an instruction to receive information about the second party customer (block 302). For example, the user interface module 280 may present a graphical user interface on the first party company interface device 240 prompting the user for information about the second party customer pertaining to the selected insurance-related document, including, but not limited to, the name of the insured on an insurance policy (e.g., name of the second party customer), the insurance policy identification (e.g., an insurance policy number), and/or information about the second party customer who will be signing the insurance-related document (e.g., name, email address, mobile phone number, etc.). In some embodiments, identification of the second party customer may cause a processor of the server to execute an instruction to automatically retrieve customer information pertaining to the selected insurance-related document from the customer database 286 and/or populate fields within the graphical user interface with the customer information for review by the user.

In one aspect, the server may execute an instruction to verify the information provided at block 302. For example, the server may compare customer information inputted into fields of the graphical user interface with customer information stored in the customer database 286. In another aspect, the server may execute an instruction to verify that all fields within the graphical user interface for the insurance-related document have been fully completed. If the customer information is incorrect or a necessary field does not have an entry or only a partial entry (e.g., only part of an insurance policy number), the server may cause the processor to throw an exception notifying the user of an error or incomplete entry, and/or cause the method to not proceed until the exception has been resolved (e.g., the error corrected or the information inputted)

Once the customer information has been entered, the method 300 may continue by the server executing an instruction causing the processor to prepare a document package (block 304) for the second party customer's signature. In one aspect, the preparation of the document package may be executed when the user submits the customer information to the server for creation of the document package. The document package may include populating a template of the selected insurance-related document with the customer information so as to merge the customer information with the template to create a first digital insurance-related document. The template of the insurance-related document, as well as templates for other insurance-related documents, may be stored in, and retrieved from, the memory 278. In another aspect, the preparation of the document package may include embedding the access code of the user, or an electronic tag associated with the access code, in the insurance-related document as metadata to uniquely associate the created insurance-related document with the user, the user's office, and/or a book of business. The status of all insurance-related documents associated with the access code may thereby be tracked, with the status provided to the user according to the user's access code.

Once the document package has been created, the method 300 may cause the processor of the server to execute an instruction to generate and transmit a request to the second party customer (block 306) to electronically sign the digital insurance-related document. In one aspect, the request to the second party customer may be in the form of an email message sent to the email address of the second party customer entered as part of the customer information at block 302. The request may be generated from a template that include general instructions for the second party customer for reviewing and signing the insurance-related document, whereby the server merges information from the document package (e.g., the name of the second party customer, the name of the insurance agent or representative associate with the insurance policy, the name of the insurance-related documents, etc.) with the template to create the request for a signature.

Those of ordinary skill in the art will readily understand that the request may take different forms according to the particular communication medium used to contact the second party customer, including, but not limited to, a recorded voice message, a short message server (SMS) text message, etc. In any event, the request notifies the second party customer that the digital insurance-related document is ready for the second party customer to review and sign. In one aspect, the request may include a link to the insurance-related document that the second party customer can follow with an input, via a mouse click, touch press, keyboard click, etc. The link may be provided as an internet hyperlink, hypertext, and/or other electronic medium linking the request to the insurance-related document. In another aspect, the link may direct the second party customer to a copy of the insurance-related document stored within the third party electronic signature service interface device 250.

The method 300 may include causing the server to execute an instruction on the processor to transmit the document package, or at least the customer information entered at block 302, as well as the embedded access code or tag to the third party electronic signature service interface device 250 (block 308). In one embodiment, the customer information may be transmitted to the third party electronic signature service interface device 250, but not the entire insurance-related document. The memory of the third party electronic signature service interface device 250 may store a copy of the template of the insurance-related document stored in the common user interface engine 270.

The third party electronic signature service interface device 250 therefore does not need the entire insurance-related document from the first party company. Rather, the server provides the third party electronic signature service interface device 250 with the information needed to create a second digital insurance-related document at the third party electronic signature service interface device 250, where the second digital insurance-related document is essentially the same as the first digital insurance-related document created at the first party company server.

The server may therefore provide the third party electronic signature service interface device 250 with the customer information, identification of the selected insurance-related document, and/or the access code or tag. The third party electronic signature service interface device 250 may then create the second digital insurance-related document by retrieving the appropriate template from memory based upon the identification of the selected insurance-related document, populating its version of the template of the selected insurance-related document with the customer information so as to merge the customer information with the template to create a first digital insurance-related document, and embed the access code or tag in metadata of the second digital insurance-related document. In one aspect, the transmission of the customer information, access code or tag, and/or document identification may occur simultaneously with, or at least independent of, the transmission of the request to the second party customer at block 306.

The method 300 may then cause the server to wait for further action on the insurance-related document. For example, the method 300 may cause the processor of the server to determine whether a status update or notification from the third party electronic signature service interface device 250 indicates that the second party customer has declined to review and/or electronically sign the insurance-related document (block 310). If such a status update or notification is provided, the method 300 may cause the server to execute an instruction on the processor to cancel the electronic signature process, in which case the method 300 ends.

If a status update or notification of decline is not received, the method 300 may wait for receipt of a notification from the third party electronic signature service interface device 250 that the second party customer has electronically signed the digital insurance-related document (block 314). Once the server receives notice that the digital insurance-related document has been electronically signed, the method 300 may cause the server to execute an instruction on the processor to retrieve the signed digital insurance-related document from the third party electronic signature service interface device 250 (block 316).

In one aspect, the server may request the third party electronic signature service interface device 250 to upload the signed digital insurance-related document to the server. In another aspect, the server may download the signed digital insurance-related document from the third party electronic signature service interface device 250. In any event, the server receives the electronically signed digital insurance-related document, and may store the electronically signed digital insurance-related document in the customer database 286.

### IV. EXEMPLARY USER INTERFACE AND RELATED FUNCTIONALITY

In one aspect, a graphical user interface for the central management or administration of electronic signatures for digital insurance-related document may be provided. The user interface may allow for a common interface for all first party company users to: (1) retrieve customer information and create an insurance-related document; (2) transmit a request for review and signing of the insurance-related document to the second party customer; (3) transmit the customer information and access code/tag to the third party electronic signature service interface device 250; (4) monitor the status of the insurance-related document; and/or (5) retrieve the electronically signed digital insurance-related document.

The graphical user interface may provide or facilitate the input, and/or viewing, of many features of the central management or administration functionality discussed herein. A number of the exemplary user interface features and functionalities are discussed below.

A. Exemplary Document Creation Functionality

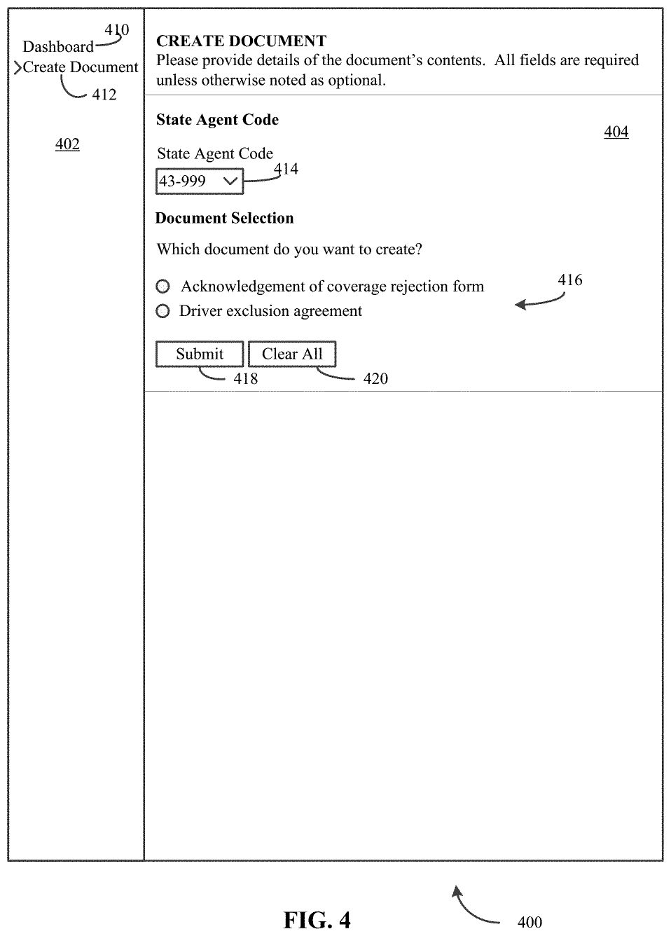

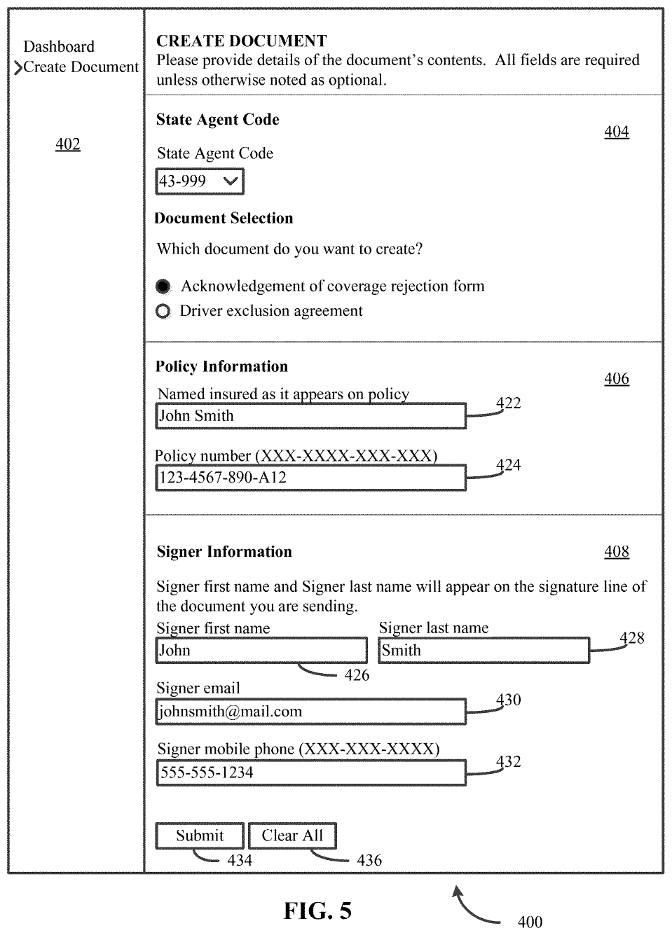

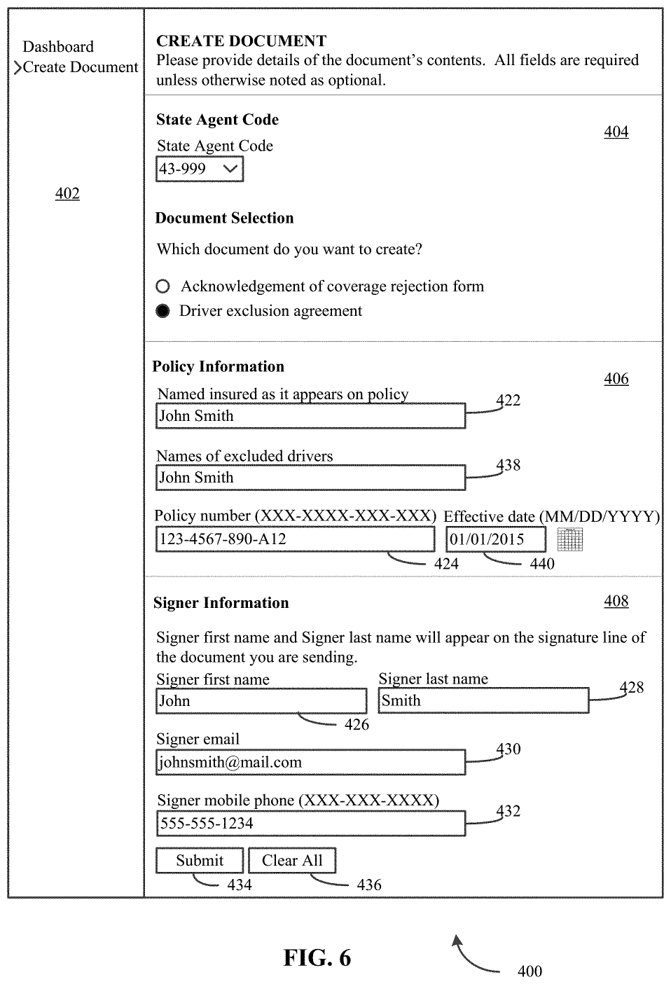

FIGS. 4-6 illustrate an exemplary graphical user interface and related functionality of an example document creation page 400. Referring to FIG. 4, a document creation page 400 may include functionality for presenting (1) a navigation menu 402; and/or (2) a document selection area 404. Referring to FIG. 5, the document creation page 400 may include additional functionality for presenting (1) an account information area 406; and/or (2) a signer information area 408 for a selected document. Referring to FIG. 6, the document creation page 400 may include additional functionality for presenting (1) an account information area 406; and/or (2) a signer information area 408 for a different selected document.

The document creation page 400 may include graphically depicting and/or visually presenting other types of information. The document creation page 400 may include additional, less, or alternate functionality, including functionality discussed elsewhere herein.

The graphical user interface may provide or facilitate the input, and/or viewing, of many features of the system and method for remotely obtaining the electronic signature for a digital insurance-related document discussed herein. A number of the exemplary user interface features and functionalities are discussed below.

i. Exemplary Navigation Menu Functionality

The document creation page 400 may display a navigation menu 402 including options that may be selected by the user to (1) view a dashboard area 410 (disclosed further below); and/or (2) create a new digital insurance-related document 412. The user enters an input, via a mouse click, touch press, keyboard click, etc., representing a selection of an option in the navigation menu 402 to create a digital insurance-related document for the second party customer's electronic signature and/or view the status of a digital insurance-related document that was created for the second party customer's electronic signature.

Selection of an option may cause the server to execute an instruction on the processor to take a particular action related to the selected option. In one aspect, the action may result in the graphical user interface graphically depicting and/or visually representing, on a display screen, areas pertaining to the desired action. For example, selection of the “Create Document” option may result in the presentation of a document selection area 404.

The navigation menu functionality may include the graphical user interface being configured to allow a user to click on a user interface element to drill down to view more details and actions that may be taken. Drilling down may result in the graphical user interface graphically depicting and/or visually representing, on the display screen, additional details or options for creating and/or viewing the status of a digital insurance-related document, etc.

ii. Exemplary Document Selection Functionality

The document creation page 400 may display a document selection area 404 including options that may be selected by the user to: (1) provide an input for an access code 414; and/or (2) select an insurance-related document for creation 416. The user enters an input, via a mouse click, touch press, keyboard click, etc., representing a selection of an option in the document selection area 404. Selection of an option may cause the server to execute an instruction on the processor to take a particular action related to the selected option.

In one aspect, the action may result in the graphical user interface graphically depicting and/or visually representing, on a display screen, areas pertaining to the desired action. For example, the input for an access code 414, such as an insurance state agent code, may be provided as a graphical drop-down menu containing all possible access codes for the user. In addition, or as an alternative, the input for an access code 414 may be left as blank field for the user to enter the access code directly.

In another aspect, options for insurance-related documents 416 may be presented for selection. The selection of one of these options may cause the server to execute an instruction on the processor to update the document creation page 400 with information and/or fields pertaining to the selected insurance-related document for entry of customer data. A graphical button 418 may be provided for the user to submit the selected options and access code information to the server for further actions pertaining to creation of the selected digital insurance related-document. In addition, a graphical button 420 may be provided for the user to clear all inputted data from the fields.

iii. Exemplary Account & Signer Information Area Functionality

Referring to FIGS. 5 and 6, entry of an access code, selection of a document, and/or input via the graphical button 418 may cause the server to execute an instruction on the processor to update or otherwise present the document creation page 400 to include the account information area 406 and signer information area 408. In one aspect, the information presented in the account information area 406 and/or signer information area 408 may be dependent upon the particular document selected from the document selection area 416. In another aspect, the information presented in the account information area 406 and/or signer information area 408 may be automatically populated by the server with data retrieved from the customer database 286. In one example, entry of data identifying a name associated with an account and/or entry of data identifying a particular account may cause the server to execute an instruction for the processor to retrieve customer data associated with the inputted name and/or account, and automatically populate the data fields within the signer information area 408.

In the example shown in FIG. 5, the account information area 406 and signer information area 408 are presented for entry of customer information pertaining to an “Acknowledgement of coverage rejection form”. The account information area 406 may include a field for entry of data about a name associated with an account 422, such as the name of an insured under an insurance policy, which may be the name of the second party customer and a field for entry of data identifying the particular account 424. The signer information area 408 may include a field for entry of data about the name of the person who will be electronically signing the digital insurance-related document 426, 428, a field for entry of data regarding contact information for the signer, such as an email address 430 and/or mobile phone number 432.

In one aspect, a graphical button 434 may be provided for the user to submit inputted data for further actions pertaining to creation of the selected digital insurance related-document. In another aspect, a graphical button 436 may be provided for the user to clear all inputted data from the fields.

In the example shown in FIG. 6, the account information area 406 and signer information area 408 are presented for entry of customer information pertaining to a “Driver exclusion agreement”. The document creation page 400 for creation of a “Driver exclusion agreement” is generally the same as the document creation page 400 for the “Acknowledgement of coverage rejection form” of FIG. 5. As such, only the differences will be discussed herein. However, those of ordinary skill in the art will readily understand how the account information area 406 and/or signer information area 408 may differ depending on the selected document, including documents not disclosed herein, which may include more or less entry of data than what has been shown. As shown in FIG. 6, the account information area 406 may include fields for entry of the names of excluded drivers under the driver exclusion agreement 438 and the effective date 440.

For the document creation page 400, instructions may be provided as to the format, completeness and/or accuracy of the data provided. If the format and/or accuracy is incorrect, and/or the inputted data incomplete, the server may generate an exception as disclosed above.

B. Exemplary Status Dashboard Functionality

Turning to FIG. 7, an exemplary feature is a status display or dashboard 500 presenting information and associated standard statuses for digital insurance-related documents that have been created (block 304), with the customer information and access code/tag sent to the third party electronic signature service interface device (block 308) and/or a notification sent to the second party customer (block 306). The status dashboard 500 may include functionality for presenting: (1) a navigation menu 502; (2) a search and filter area 504; and/or (3) a status area 506. The status dashboard 500 may include graphically depicting and/or visually presenting other types of information. The status dashboard 500 may include additional, less, or alternate functionality, including functionality discussed elsewhere herein.

i. Exemplary Navigation Menu Functionality

The status dashboard 500 may display a navigation menu 502 including options that may be selected by the user to (1) view a dashboard 508; and/or (2) create a new digital insurance-related document 510. Similar to the navigation menu 402 disclosed above, the user may enter an input, via a mouse click, touch press, keyboard click, etc., representing a selection of an option in the navigation menu 502 to create a digital insurance-related document for the second party customer's electronic signature and/or view the status of a digital insurance-related document that was created for the second party customer's electronic signature. Selection of an option may cause the server to execute an instruction on the processor to take a particular action related to the selected option.

In one aspect, the action may result in the graphical user interface graphically depicting and/or visually representing, on a display screen, areas pertaining to the desired action. For example, selection of the “Dashboard” option may result in the presentation of a status dashboard 500.

The navigation menu functionality may include the graphical user interface being configured to allow a user to click on a user interface element to drill down to view more details and actions that may be taken. Drilling down may result in the graphical user interface graphically depicting and/or visually representing, on the display screen, additional details or options for creating and/or viewing the status of a digital insurance-related document, etc.

ii. Exemplary Search and Filter Area Functionality

The status dashboard 500 may display a search and filter area 504 including options that may be selected by the user to: (1) specify documents sent out to the second and third parties according to a particular date range; (2) specify documents sent out under a particular access code; (3) specify a particular document or subset of documents through a keyword search; and/or (4) navigate through the search results. The user may enter an input, via a mouse click, touch press, keyboard click, etc., representing a selection of a search or filter option in the search and filter area 504. Selection of an option may cause the server to execute an instruction on the processor to take a particular action related to the selected option.

In one aspect, the action may result in the graphical user interface graphically depicting and/or visually representing, on a display screen, areas pertaining to the desired search and/or filter criteria. For example, the input for a particular date range and access code may return all documents sent out to the second and third parties within that range under that access code within the status area 506. In another example, a keyword search for the name of the name of the second party customer may return all documents sent out with respect to that name in the status area 506.

iii. Exemplary Status Area Functionality

The status dashboard 500 may display a status area 506 that presents to the user: (1) the name of the agent who sent the document; (2) the name of the second party customer for whom an electronic signature is sought; (3) a description of the document; (4) a status of the document; (5) the date the document was transmitted to the second and third parties; and/or (6) actions that may be taken in view of the status of the document. The status of the documents may be updated by querying the third party electronic signature service interface device 250 for the status of the document or otherwise receiving updates from the third party electronic signature service interface device 250 as to whether the document has been accessed by the second party customer (e.g., “in progress”), signed by the second party customer (e.g., “completed”), downloaded to the common user interface engine 270 (e.g., “downloaded”), or the second party customer declined to review and/or electronically sign the document (e.g., “declined to sign”).

As may be dependent upon the status of the document, different actions may be available via the status dashboard 500. For example, a document that has been completed (e.g., electronically signed by the second party customer) may include an option to download the document, in response to which the server may execute an instruction on the processor to retrieve the document from the third party electronic signature service interface device 250 (block 316). As another example, a document that is still in progress may be voided by the user, thereby cancelling the signing process. Each document may be viewed using a view option, regardless of status.

Of course the categories on this list are only examples and those of ordinary skill in the art will recognize that a variety of information may be presented and used. In some embodiments, the status messages may be standardized across different documents. For example, the same status messages may be standardized across financial product lines (such as loans) and insurance product lines (such as car insurance). Accordingly, the work flow of each business line may be mapped to the standard statuses. The exemplary list status area 506 may include additional, fewer, or alternate statuses, including those discussed elsewhere herein.

### V. EXEMPLARY FLOWCHART FOR REVIEWING & ELECTRONICALLY SIGNING DOCUMENTS

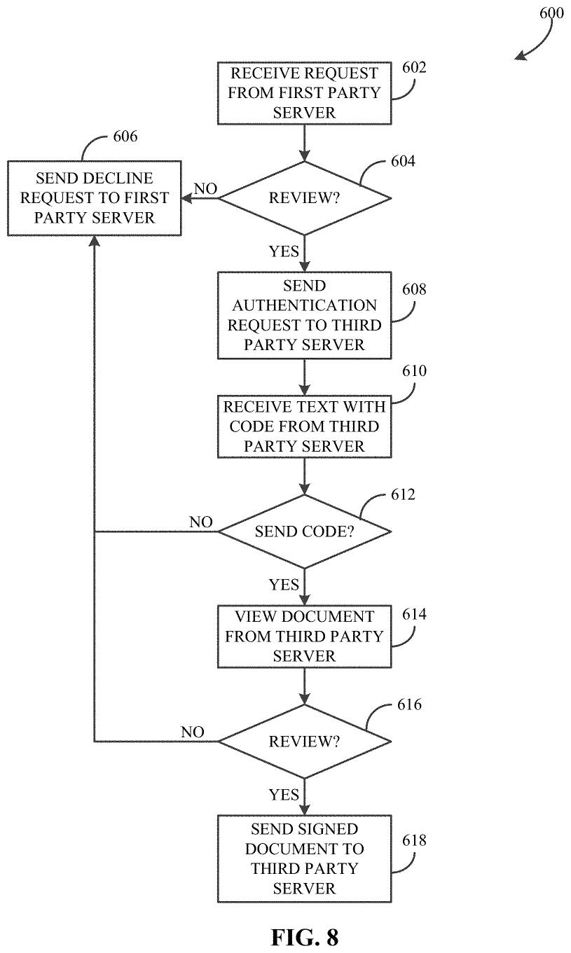

FIG. 8 is a high level chart of an exemplary method, routine or process 600 for reviewing and/or electronically signing a digital insurance-related document. A user, such as the second party customer, may use a second party customer interface device 202, such as the computing device 122 and/or communication device 124 illustrated in FIG. 1, to access the digital insurance-related document from the third party electronic signature service interface device 250. The method 600 may begin when the user receives a notification or request (block 602) from the common user interface engine 270, notifying the user that a digital insurance-related document has been created and is ready for the user to review and electronically sign.

In one aspect, the user may receive an email message from the common user interface engine 270. As disclosed above, the request may include a link to the insurance-related document that the second party customer can follow with an input, via a mouse click, touch press, keyboard click, etc., which directs the second party customer to a copy of the insurance-related document stored within the third party electronic signature service interface device 250.

In one embodiment, if the user ignores the request after a certain period of time or indicates via a link in the request notification that the user declines to review and/or sign the digital insurance-related document (block 604), the processor of the second party interface device 202 may execute an instruction to send a response indicating the decline to the third party electronic signature service interface device 250 (block 606). The third party electronic signature service interface device 250 may then update the status of the document as “declined to sign” to the common user interface engine 270.

Additionally or alternatively, if the user selects the option to view the document or otherwise provides an input to proceed with reviewing and signing the document, the processor of the second party customer interface device 202 may execute an instruction to send an authentication request to the third party electronic signature service interface device 250 (block 608). The authentication request may cause the third party electronic signature service interface device 250 to return a message to the second party customer interface device 202, and particularly the computing device 122, to confirm the identity of the second party customer. In one aspect, the message requests the user to select and/or confirm an alternate form of communication (e.g., different email account, mobile phone number, etc.).

Selection and/or confirmation of an alternate form of communication may cause the processor of the second party customer interface device to execute an instruction to transmit the information to the third party electronic signature service interface device 250. The third party electronic signature service interface device 250 may then transmit an access code for the second party customer via the specified alternate form of communication.

For example, the user may receive the access code (block 610) via a device (e.g., a text via the communication device 124 which corresponds to the mobile phone number provided during creation of the document) and/or account different than the device and/or account by via the request was received at block 602 (e.g., an email via the computing device 122 which corresponds to the email address provided during creation of the document). As such, the access code may be provided via a separate communication channel in order to verify the identity of the second party consumer, where the second communication channel is a known form of communication with the second party customer.

In another aspect, selection and/or confirmation of an alternate form of communication may trigger receipt of a further message or update from the third party electronic signature service interface device 250 via the first communication channel that prompts the second party customer for entry of the access code received via the second communication channel. If the user enters and sends the access code to the third party electronic signature service interface device 250 (block 612), the user may be provided with access to the digital insurance-related document (block 614).

In one aspect, the digital insurance-related document may be accessed via the internet using a web browser and a secure communication channel with the third party electronic signature service interface device 250. In another aspect, the digital insurance-related document may be downloaded from the third party electronic signature service interface device 250 via a secure communication channel. However, the user may also decline to enter the code, either by ignoring the message from the third party electronic signature service interface device 250 prompting for the access code after a period of time, or indicating that the user would like the cancel the signing process, in which case the processor of the second party interface device 202 may execute an instruction to send a response indicating the decline to the third party electronic signature service interface device 250 (block 606), and the third party electronic signature service interface device 250 may update the status of the document as “declined to sign” to the common user interface engine 270.

The user may once again be given the option to review and electronically sign the digital insurance-related document (block 616). If the user declines, the processor of the second party interface device 202 may execute an instruction to send a response indicating the decline to the third party electronic signature service interface device 250 (block 606), and/or the third party electronic signature service interface device 250 may update the status of the document as “declined to sign” to the common user interface engine 270. Otherwise, if the user accepts, the user may proceed with reviewing the digital insurance-related document, and providing an electronic signature, as disclosed further below. Once completed, the user may submit the electronically signed digital insurance-related document, such that the processor of the second party interface device 202 may execute an instruction to send the electronically signed digital insurance-related document, or at least the electronic signature, to the third party electronic signature service interface device 250 (block 618).

### VI. EXEMPLARY COMMUNICATIONS AND DISPLAYS FOR THE CUSTOMER

In one aspect, a graphical user interface for the review and electronic signing of a digital insurance-related document may be provided. The user interface may allow for a second party customer to: (1) receiving notification that a digital insurance-related document is ready to be reviewed and signed; (2) authenticate the identity of the second party customer; (3) transmit the access code to the third party electronic signature service interface device 250; (4) review the insurance-related document; and/or (5) electronically sign the digital insurance-related document.

The graphical user interface may provide or facilitate the input, and/or viewing, of many features of the functionality discussed herein. A number of the exemplary user interface features and functionalities are discussed below.

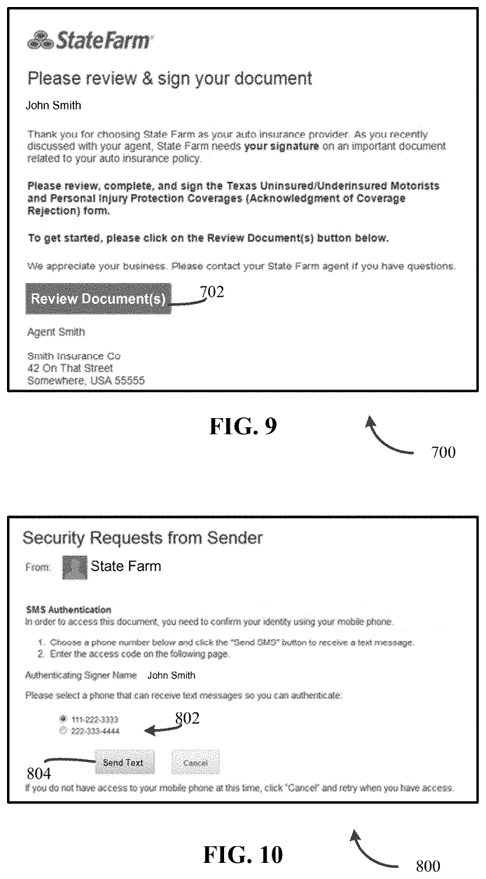

FIGS. 9-13 illustrate an exemplary graphical user interface and related functionality on the second party customer side of reviewing and electronically signing the digital insurance-related document. Referring to FIG. 9, an example of the request 700 transmitted from the common user interface engine 270 at block 306 of FIG. 3, and as received at block 602 of FIG. 8, is depicted. As shown in FIG. 9, the request may address the second party customer by name such that the second party customer understands the request is intended for him/her. In one aspect, the request may include notification that a digital insurance-related document is ready for the second party customer to review and electronically sign. As disclosed, the request may include a link 702 to the insurance-related document that the second party customer may follow with an input, via a mouse click, touch press, keyboard click, etc.

Referring to FIG. 10, an example of the message 800 to the second party customer interface device 202 to confirm the identity of the second party customer is depicted. As shown in FIG. 10, the message 800 may include instructions for the second party customer to verify his/her identity in order to receive an access code to view the digital insurance-related document. Part of the authentication may include having the second party customer confirm or select a different channel of communication by which to receive the access code, such as a mobile phone number 802. The message 800 may include a link 804 to confirm the second communication channel via a mouse click, touch press, keyboard click, etc. and/or receive the access code.

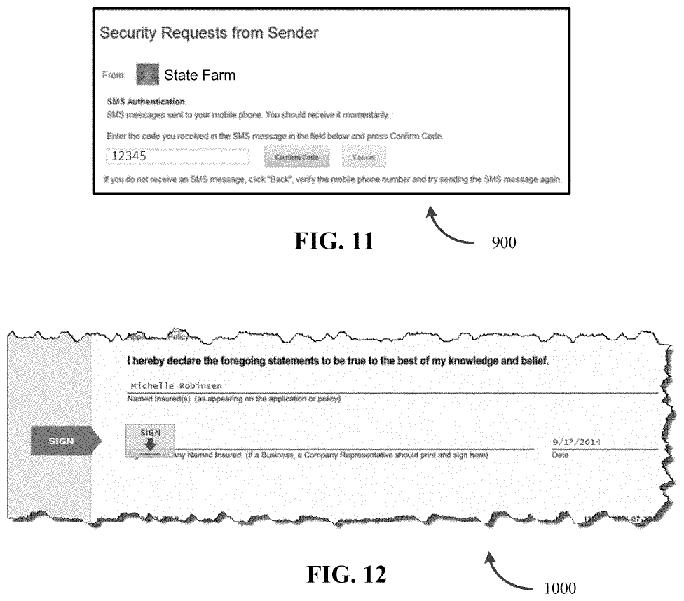

Referring to FIG. 11, an example of a further message 900 to the second party customer interface device 202 to enter the access code is depicted. As shown in FIG. 11, the message 900 may include instructions for the second party customer to enter the access code received by the second communication channel.

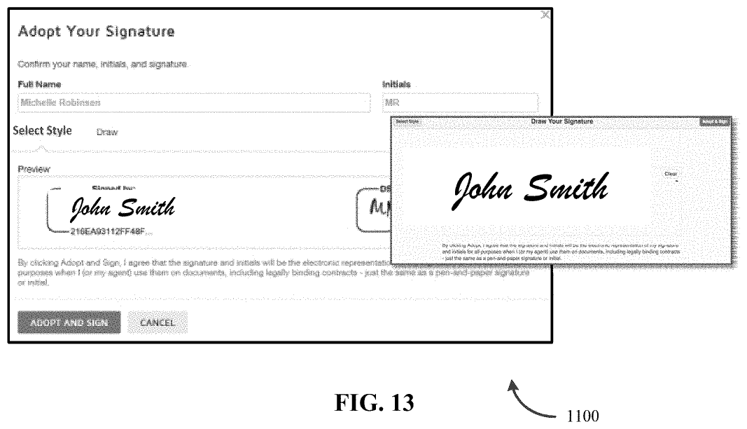

Referring to FIG. 12, an example of a portion of the digital insurance-related document 1000 is depicted showing the second party customer where to sign. Referring to FIG. 13, an example of electronically signing the digital insurance-related document 1100 is depicted. In one aspect, the third party electronic signature service interface device 250 may facilitate the entry of the second party customer's signature. For example, the third party electronic signature service interface device 250 may save an image of the second party customer's signature from a previous process of electronically signing a document. The second party customer then has the option of selecting that electronic signature for inclusion in the digital insurance-related document. In another aspect, the third party electronic signature service interface device 250 may give the second party customer the option of “drawing” his/her signature, for example by using touch press, a stylus, a mouse, etc. In yet another aspect, the second party customer may select a particular font for the electronic signature.

### VII. EXEMPLARY FLOWCHART FOR ELECTRONIC SIGNATURE

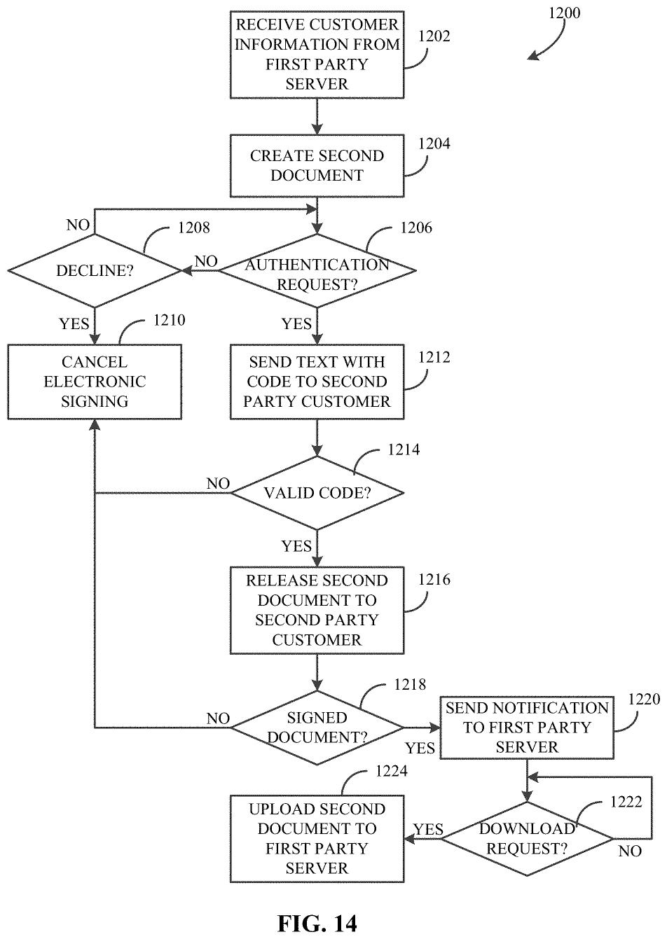

FIG. 14 is a high level chart of an exemplary method, routine or process 1200 for facilitating the electronic signature of a digital insurance-related document. The third party electronic signature service interface device 250 may execute the method 1200. The method 1200 may begin when the third party electronic signature service interface device 250 receives the digital insurance-related document package, or at least the customer information, document identification and access code/tag, from the common user interface engine 270 (block 1202). As previously disclosed, the third party electronic signature service interface device 250 may create a second digital insurance-related document (block 1204) by retrieving the appropriate document template from memory using the document identification, populating the template with the customer data, and/or embedding the access code/tag in the document. The second digital insurance-related document is essentially a copy of the digital insurance-related document created with the common user interface engine 270 at block 304 of FIG. 3.

The method 1200 may then wait for the authentication request from the second party customer interface device 202 (block 1206). If no authentication request is received, or if something other than an authentication request is received, from the second party customer interface device 202, the method 300 may determine whether the second party customer has declined to electronically sign the digital insurance-related document (block 1208). For example, the second party customer may expressly decline, or implicitly decline by failing to respond after a period of time. If the method 300 has determined the second party customer has declined to electronically sign the digital insurance-related document, the method 300 may cancel the electronic signing process (block 1210), and provide notice to the common user interface engine 270 that the second party customer declined to electronically sign.

If an authentication request is received, the method 1200 may send the access code to the second party customer via the second communication channel (block 1212), and await a return of the access code via the first communication channel (block 1214). If the access code is received via the first communication channel, and is valid, the third party electronic signature service interface device 250 may provide the second party customer interface device 202 with access to the second digital insurance-related document (block 1216).

In one aspect, the third party electronic signature service interface device 250 may upload and/or allow the second digital insurance-related document to be downloaded to the second party customer interface device 202. In another aspect, the third party electronic signature service interface device 250 may enable the second party customer interface device 202 to remotely view the second digital insurance-related document, without providing a copy of the second digital insurance-related document to the second party customer interface device 202.

The method 300 may wait for receipt of the second party customer's electronic signature (block 1218). If an electronic signature is not received after a specified time, or if the second party customer provides an indication that he/she declines to electronically sign the digital insurance-related document, the method 300 may return to block 1210 to cancel the process and/or notify the common user interface engine 270. If an electronic signature is received from the second party customer, the method 300 may send a notification to the common user interface engine 270 that the digital insurance-related document has been electronically signed by the second party customer (block 1220).

The method 300 may then wait for a download request from the common user interface engine 270 to retrieve the electronically signed digital insurance-related document (block 1222). If such a request is receive, the third party electronic signature service interface device 250 may upload the second digital insurance-related document with the electronic signature to the common user interface engine 270 (block 1224) or otherwise allow the second digital insurance-related document with the electronic signature to be retrieved by the common user interface engine 270 from the third party electronic signature service interface device 250.

In one aspect, the third party electronic signature service interface device 250 may embed the electronic signature in the second digital insurance-related document. In another aspect, the third party electronic signature service interface device 250 may simply provide the electronic signature, which may be an image file, to the common user interface engine 270, whereby the common user interface engine 270 embeds the electronic signature in the first digital insurance-related document.

### VIII. EXEMPLARY DATA SERVERS

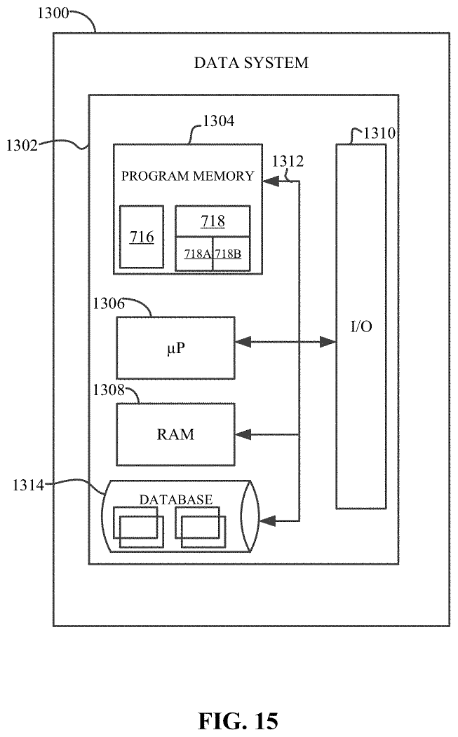

Referring now to FIG. 15, a data server 1300 may include a controller 1302. Exemplary data servers may include the servers 114 and 130 illustrated in FIG. 1. The controller 1302 may include a program memory 1304, a microcontroller or a microprocessor (μP) 1306, a random-access memory (RAM) 1308, and/or an input/output (I/O) circuit 1310, all of which are interconnected via an address/data bus 1312. The program memory 1304 may store computer-executable instructions, which may be executed by the microprocessor 1306. In one aspect, the controller 1302 may also include, or otherwise be communicatively connected to, a database 1314 or other data storage mechanism (e.g., one or more hard disk drives, optical storage drives, solid state storage devices, etc.). It should be appreciated that although FIG. 13 depicts only one microprocessor 1306, the controller 1302 may include multiple microprocessors 1306. Similarly, the memory 1304 of the controller 1302 may include multiple RAMs 1316 and multiple program memories 1318, 1318A and 1318B storing one or more corresponding application modules, according to the controller's particular configuration. The data server 1300 may also include specific routines to be performed by the data server 1300.

Although FIG. 13 depicts the I/O circuit 1310 as a single block, the I/O circuit 1310 may include a number of different types of I/O circuits (not depicted). The RAM(s) 1308, 1304 and the program memories 1318, 1318A and 1318B may be implemented in a known form of computer storage media, including but not limited to, semiconductor memories, magnetically readable memories, and/or optically readable memories, for example, but does not include transitory media such as carrier waves. The data server may include additional, fewer, or alternate components, including those discussed elsewhere herein.

### IX. EXEMPLARY METHOD OF REMOTELY OBTAINING A SIGNATURE

In one aspect, a computer-implemented method of remotely obtaining a signature for an insurance-related document may be provided. The method may include (1) receiving, by a first party user interface, customer-associated data for a second party customer; (2) creating, by the first party user interface, a first insurance-related digital document from the received customer-associated data; (3) generating and transmitting, by the first party user interface in response to the creation of the first insurance-related digital document, a data request for a signature to a second party customer communication medium; (4) transmitting, by the first party user interface in response to the creation of the first insurance-related digital document, the customer-associated data to a third party server, wherein the third party is an electronic signature service that creates a second insurance-related digital document with the customer-associated data, electronically authenticates the second party, and/or facilitates an electronic exchange of the second insurance-related digital document between the first party and second party; and/or (5) receiving, by the first party user interface, the second insurance-related digital document with a digital signature of the second party customer from the third party server. As a result, obtaining electronic signatures remotely from customer on insurance-related documents may be facilitated. Additionally or alternatively, unique access codes may enhance security during data transmission, and/or upon receipt of electronically signed documents, insurance policies, premiums, discounts, rates, coverages, deductibles, limits, etc. may be updated, added, and/or generated. The method may include additional, fewer, or alternate actions, including those discussed elsewhere herein.

For example, creating the first insurance-related digital document may include populating, by the first party user interface, a template of the first insurance-related digital document with the customer-associated data, where the template comprises one or more fields for entry of the customer-associated data. The method may further include (1) receiving, by the first party user interface, an input selecting the first insurance-related document for creation from among a plurality of insurance-related digital documents; and/or (2) generating, upon a display unit by the first party user interface in response to the input, the template of the first insurance-related digital document, wherein the fields of the template are dependent upon the selection of the insurance-related digital document from among the plurality of insurance-related digital documents. In addition, the method may include automatically retrieving, by the first party user interface in response to the input, the customer-associated data from a database.

The method may include creating, by the third party server, the second insurance-related digital document from the received customer-associated data. Creating the second insurance-related digital document may include populating a template of the second insurance-related digital document with the customer-associated data.

The method may also include generating, upon a display unit by the first party user interface, a status of the second insurance-related digital document. The method may include receiving, by the first party user interface, a notification from the third party server that the second insurance-related digital document includes the digital signature of the second party customer. In such a case, receiving the second insurance-related digital document with a digital signature of the second party customer from the third party server may include downloading, by the first party user interface in response to an input to download, the second insurance-related digital document with the digital signature of the second party customer from the third party server.

Creating the first insurance-related digital document from the received customer-associated data may include embedding, by the first party user interface, metadata of a tag uniquely associated with a place of business in the first insurance-related digital document. In such a case, transmitting the customer-associated data to the third party server further may include transmitting, by the first party user interface in response to the creation of the first insurance-related digital document, the metadata of the tag.

The first party may include a plurality of places of business. In such a case, the first party interface is common among the plurality of places of business. Also, in such a case, each place of business may be uniquely associated with an access code, and customer-associated data for second party customers may be restricted to one of the access codes such that receiving customer-associated data for a second party customer, creating a first insurance-related digital document from the received customer-associated data, generating and transmitting a data request for a signature to a second party customer communication medium, transmitting the customer-associated data to a third party server, and/or receiving the second insurance-related digital document with a digital signature of the second party customer from the third party server may be first dependent upon entry of the access code associated with the customer-associated data.

In another aspect, a computer-implemented method for remotely obtaining a signature for an insurance-related document may be provided. The method may include (1) receiving, by a user interface associated with an insurance provider, customer-associated data for a customer; (2) creating, by the user interface, a first insurance-related digital document from the received customer-associated data; (3) generating and transmitting, by the user interface in response to the creation of the first insurance-related digital document, a data request for a signature to a customer communication medium; (4) transmitting, by the user interface in response to the creation of the first insurance-related digital document, the customer-associated data to a third party server, wherein the third party is an electronic signature service that creates a second insurance-related digital document with the customer-associated data, electronically authenticates the second party, and facilitates an electronic exchange of the second insurance-related digital document between the insurance provider and the customer; (5) receiving, by the user interface, the second insurance-related digital document with a digital signature of the customer from the third party server; and/or (6) updating an insurance policy, via a processor, upon receipt of the digital signature of the customer such that remotely obtaining a digital or electronic signature of the customer on insurance-related documents and/or timely updating an insurance policy for the customer is facilitated. The method may include additional, less, or alternate functionality, including that discussed elsewhere herein.

### X. EXEMPLARY COMPUTER SYSTEM FOR OBTAINING A SIGNATURE

In one aspect, a computer system for remotely obtaining a signature for an insurance-related document may be provided. The system may include (1) one or more processors; and (2) one or more memories coupled to the one or more processors. The one or more memories may include non-transitory computer executable instructions stored therein. The instructions, when executed by the one or more processors, may cause the one or more processors to: (1) receive customer-associated data for a second party customer; (2) create a first insurance-related digital document from the received customer-associated data; (3) generate and transmit, in response to the creation of the first insurance-related digital document, a data request for a signature to a second party customer communication medium; (4) transmit, in response to the creation of the first insurance-related digital document, the customer-associated data to a third party server, wherein the third party is an electronic signature service that creates a second insurance-related digital document with the customer-associated data, electronically authenticates the second party and/or facilitates an electronic exchange of the second insurance-related digital document between the first party and second party; and/or (5) receive the second insurance-related digital document with a digital signature of the second party customer from the third party server. As a result, electronic signatures on insurance-related documents may be remotely acquired from customers. Additionally or alternatively, unique access codes may be generated and/or used by the system to enhance security during data transmission, and/or upon receipt of electronically signed documents, insurance policies, premiums, discounts, rates, coverages, deductibles, limits, etc. may be updated, added, and/or generated by the system. The system may include additional, less, or alternate functionality, including that discussed elsewhere herein.

For example, the instructions to create the first insurance-related digital document may include instructions to cause the one or more processors to populate a template of the first insurance-related digital document with the customer-associated data, where the template comprises one or more fields for entry of the customer-associated data. The instructions may also cause the one or more processors to (1) receive an input selecting the first insurance-related document for creation from among a plurality of insurance-related digital documents; and/or (2) generate, in response to the input, the template of the first insurance-related digital document, wherein the fields of the template are dependent upon the selection of the insurance-related digital document from among the plurality of insurance-related digital documents. In addition, the instructions may cause the one or more processors to automatically retrieve, in response to the input, the customer-associated data from a database.

The system may also include instructions that may cause the third party server to create the second insurance-related digital document from the received customer-associated data. These instructions may include instructions that may cause the third party server to populate a template of the second insurance-related digital document with the customer-associated data.

The instructions may also cause the one or more processors to generate, upon a display unit, a status of the second insurance-related digital document. In addition, the instructions may cause the one or more processors to receive a notification from the third party server that the second insurance-related digital document includes the digital signature of the second party customer. In this case, the instructions to cause the one or more processors to receive the second insurance-related digital document with a digital signature of the second party customer from the third party server may include instructions to cause the one or more processors to download, in response to an input to download, the second insurance-related digital document with the digital signature of the second party customer from the third party server.

The instructions to cause the one or more processors to create the first insurance-related digital document from the received customer-associated data may further include instructions to cause the one or more processors to embed metadata of a tag uniquely associated with a place of business in the first insurance-related digital document. In such a case, the instructions to cause the one or more processors to transmit, in response to the creation of the first insurance-related digital document, the customer-associated data to the third party server may include instructions to cause the one or more processors to transmit, in response to the creation of the first insurance-related digital document, the metadata of the tag.

The first party may include a plurality of places of business. In such a case, the first party interface is common among the plurality of places of business. Also, in such a case, each place of business may be uniquely associated with an access code, and customer-associated data for second party customers may be restricted to one of the access codes. In this case, the instructions to cause the one or more processors to receive customer-associated data for a second party customer, create a first insurance-related digital document from the received customer-associated data, generate and transmit a data request for a signature to a second party customer communication medium, transmit the customer-associated data to a third party server, and/or receive the second insurance-related digital document with a digital signature of the second party customer from the third party server may be first dependent upon entry of the access code associated with the customer-associated data.

### XI. ADDITIONAL CONSIDERATIONS

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain aspects are described herein as including logic or a number of components or modules. Modules may constitute either software modules (e.g., code stored on a machine-readable medium) or hardware modules. A hardware module is tangible unit capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In some cases, a hardware module may include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. It will be appreciated that the decision to implement a hardware module in dedicated and permanently configured circuitry or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering aspects in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In aspects in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example aspects, the processor or processors may be located in a single location (e.g., within a home environment, an office environment or as a server farm). In other aspects, however, the processors may be distributed across a number of locations.

The one or more processors may also operate to support performance of the relevant operations in a “cloud computing” environment or as a SaaS. For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other example aspects, the one or more processors or processor-implemented modules may be distributed across a number of geographic locations.

Some portions of this specification are presented in terms of algorithms or symbolic representations of operations on data stored as bits or binary digital signals within a machine memory e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one aspect” or “an aspect” means that a particular element, feature, structure, or characteristic described in connection with the aspect is included in at least one aspect. The appearances of the phrase “in one aspect” in various places in the specification are not necessarily all referring to the same aspect.

Some aspects may be described using the expression “coupled” and “connected” along with their derivatives. For example, some aspects may be described using the term “coupled” to indicate that two or more elements are in direct physical or electrical contact. The term “coupled,” however, may also mean that two or more elements are not in direct contact with each other, but yet still co-operate or interact with each other. The aspects are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, condition A or B is satisfied by any one of the following: A is true (or present) and B is false (or not present), A is false (or not present) and B is true (or present), and both A and B are true (or present).

In addition, use of the “a” or “an” are employed to describe elements and components of the aspects herein. This is done merely for convenience and to give a general sense of the description. This description should be read to include one or at least one and the singular also includes the plural unless it is obvious that it is meant otherwise.

Although the foregoing text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

Upon reading this disclosure, those of ordinary skill in the art will appreciate still additional alternative structural and functional designs for providing database application infrastructure management through the disclosed principles herein. Thus, while particular aspects and applications have been illustrated and described, it is to be understood that the disclosed aspects are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

1. A method executed by a computer comprising a processor and a memory, for remotely obtaining a signature for an insurance-related document, the method comprising:
receiving, by a processor associated with a first party graphical user interface accessed by an agent or representative of a first party, wherein the first party graphical user interface is distinct from any third party electronic signature service applications, customer-associated data for a second party customer;
creating, by the processor associated with the first party graphical user interface, a first insurance-related digital document from the received customer-associated data;
generating and transmitting, by the processor associated with the first party graphical user interface in response to the creation of the first insurance-related digital document, a data request for a signature to a second party customer communication medium;
transmitting, by the processor associated with the first party graphical user interface in response to the creation of the first insurance-related digital document, the customer-associated data to a third party electronic signature service server, wherein the third party electronic signature service:
creates a second insurance-related digital document with the customer-associated data separate from the first insurance-related digital document using a template of the insurance-related digital document previously provided by the first party,
electronically authenticates the second party, and
facilitates an electronic exchange of the second insurance-related digital document between the first party and second party via the second party customer communication medium;
transmitting, by the processor associated with the first party graphical user interface, an access code to the third party electronic signature service server, wherein the access code is a single access code usable by all agents or representatives of the first party; and
receiving, by the processor associated with the first party graphical user interface that is distinct from any third party electronic signature service applications, the second insurance-related digital document, with a digital signature of the second party customer, from the third party electronic signature service server to facilitate remotely obtaining digital signatures of customers on insurance-related documents.

2. The method of claim 1, wherein creating, by the processor associated with the first party graphical user interface, the first insurance-related digital document comprises populating, by the first party graphical user interface, a template of the first insurance-related digital document with the customer-associated data, where the template comprises one or more fields for entry of the customer-associated data.

3. The method of claim 2, further comprising:
receiving, by the processor associated with the first party graphical user interface, an input selecting the first insurance-related document for creation from among a plurality of insurance-related digital documents;
generating, upon a display unit by the processor associated with the first party graphical user interface in response to the input, the template of the first insurance-related digital document, wherein the fields of the template are dependent upon the selection of the insurance-related digital document from among the plurality of insurance-related digital documents.

4. The method of claim 3, further comprising automatically retrieving, by the processor associated with the first party graphical user interface in response to the input, the customer-associated data from a database.

5. The method of claim 1, further comprising:
creating, by the third party server, the second insurance-related digital document from the received customer-associated data,
wherein creating, by the third party server, the second insurance-related digital document comprises populating a template of the second insurance-related digital document with the customer-associated data.

6. The method of claim 1, further comprising:
generating, upon a display unit by the processor associated with the first party graphical user interface, a status of the second insurance-related digital document.

7. The method of claim 1, further comprising:
receiving, by the processor associated with the first party graphical user interface, a notification from the third party server that the second insurance-related digital document includes the digital signature of the second party customer,
wherein receiving, by the processor associated with the first party graphical user interface, the second insurance-related digital document with a digital signature of the second party customer from the third party server comprises downloading, by the first party graphical user interface in response to an input to download, the second insurance-related digital document with the digital signature of the second party customer from the third party server.

8. The method of claim 1, wherein creating, by the processor associated with the first party graphical user interface, the first insurance-related digital document from the received customer-associated data further comprises embedding, by the first party graphical user interface, metadata of a tag uniquely associated with a place of business in the first insurance-related digital document, and
wherein transmitting, by the processor associated with the first party graphical user interface in response to the creation of the first insurance-related digital document, the customer-associated data to the third party server further comprises transmitting, by the first party graphical user interface in response to the creation of the first insurance-related digital document, the metadata of the tag.

9. The method of claim 1, wherein the first party comprises a plurality of places of business, and wherein the first party interface is common among the plurality of places of business.

10. The method of claim 9, wherein each place of business is uniquely associated with an access code, and wherein customer-associated data for second party customers is restricted to one of the access codes such that receiving customer-associated data for a second party customer, creating a first insurance-related digital document from the received customer-associated data, generating and transmitting a data request for a signature to a second party customer communication medium, transmitting the customer-associated data to a third party server, and receiving the second insurance-related digital document with a digital signature of the second party customer from the third party server is first dependent upon entry of the access code associated with the customer-associated data.

11. A computer system for remotely obtaining a signature for an insurance-related document, the system comprising:
one or more processors; and
one or more memories coupled to the one or more processors;
the one or more memories including non-transitory computer executable instructions stored therein that, when executed by the one or more processors, cause the one or more processors to:
receive, by a first party graphical user interface accessed by an agent or representative of a first party, wherein the first party graphical user interface is distinct from any third party electronic signature service applications, customer-associated data for a second party customer;
create a first insurance-related digital document from the received customer-associated data;
generate and transmit, in response to the creation of the first insurance-related digital document, a data request for a signature to a second party customer communication medium;
transmit, in response to the creation of the first insurance-related digital document, the customer-associated data to a third party electronic signature service server without transmitting the first insurance-related digital document to the third party electronic signature service server, wherein the third party electronic signature service:
creates a new, second insurance-related digital document with the customer-associated data, distinct from the first insurance-related digital document using a template of the insurance-related digital document previously provided by the first party,
electronically authenticates the second party, and
facilitates an electronic exchange of the second insurance-related digital document between the first party and second party via the second party customer communication medium;
transmit an access code to the third party electronic signature service server, wherein the access code is a single access code usable by all agents or representatives of the first party; and
receive, by the first party graphical user interface that is distinct from any third party electronic signature service applications, the second insurance-related digital document with a digital signature of the second party customer from the third party electronic signature service server to facilitate remotely acquiring electronic signatures on insurance-related documents.

12. The system of claim 11, wherein the non-transitory computer executable instructions to cause the one or more processors to create the first insurance-related digital document comprise non-transitory computer executable instructions to cause the one or more processors to populate a template of the first insurance-related digital document with the customer-associated data, where the template comprises one or more fields for entry of the customer-associated data.

13. The system of claim 12, further comprising non-transitory computer executable instructions to cause the one or more processors to:
receive an input selecting the first insurance-related document for creation from among a plurality of insurance-related digital documents;
generate, in response to the input, the template of the first insurance-related digital document, wherein the fields of the template are dependent upon the selection of the insurance-related digital document from among the plurality of insurance-related digital documents.

14. The system of claim 13, further comprising non-transitory computer executable instructions to cause the one or more processors to:
automatically retrieve, in response to the input, the customer-associated data from a database.

15. The system of claim 11, further comprising non-transitory computer executable instructions to cause the third party server to:
create the second insurance-related digital document from the received customer-associated data by populating a template of the second insurance-related digital document with the customer-associated data.

16. The system of claim 11, further comprising non-transitory computer executable instructions to cause the one or more processors to:
generate, upon a display unit, a status of the second insurance-related digital document.

17. The system of claim 11, further comprising non-transitory computer executable instructions to cause the one or more processors to:
receive a notification from the third party server that the second insurance-related digital document includes the digital signature of the second party customer,
wherein the non-transitory computer executable instructions to cause the one or more processors to receive the second insurance-related digital document with a digital signature of the second party customer from the third party server comprise non-transitory computer executable instructions to cause the one or more processors to download, in response to an input to download, the second insurance-related digital document with the digital signature of the second party customer from the third party server.

18. The system of claim 11, wherein the non-transitory computer executable instructions to cause the one or more processors to create the first insurance-related digital document from the received customer-associated data further comprise non-transitory computer executable instructions to cause the one or more processors to embed metadata of a tag uniquely associated with a place of business in the first insurance-related digital document, and
wherein the non-transitory computer executable instructions to cause the one or more processors to transmit, in response to the creation of the first insurance-related digital document, the customer-associated data to the third party server further comprise non-transitory computer executable instructions to cause the one or more processors to transmit, in response to the creation of the first insurance-related digital document, the metadata of the tag.

19. The system of claim 11, wherein each place of business is uniquely associated with an access code, and wherein customer-associated data for second party customers is restricted to one of the access codes, wherein the non-transitory computer executable instructions to cause the one or more processors to receive customer-associated data for a second party customer, create a first insurance-related digital document from the received customer-associated data, generate and transmit a data request for a signature to a second party customer communication medium, transmit the customer-associated data to a third party server, and receive the second insurance-related digital document with a digital signature of the second party customer from the third party server are first dependent upon entry of the access code associated with the customer-associated data.

20. A computer-implemented method for remotely obtaining a signature for an insurance-related document, the method comprising:
receiving, by a graphical user interface associated with an insurance provider accessed by an agent or representative of the insurance provider, wherein the graphical user interface associated with the insurance provider is distinct from any third party electronic signature service applications, customer-associated data for a customer;
creating, by the graphical user interface associated with the insurance provider, a first insurance-related digital document from the received customer-associated data;
generating and transmitting, by the graphical user interface associated with the insurance provider in response to the creation of the first insurance-related digital document, a data request for a signature to a customer communication medium;
transmitting, by the graphical user interface associated with the insurance provider in response to the creation of the first insurance-related digital document, the customer-associated data to a third party electronic signature service server without transmitting the first insurance-related digital document to the third party electronic signature service server, wherein the third party electronic signature service:
creates a new, second insurance-related digital document with the customer-associated data, distinct from the first insurance-related digital document using a template of the insurance-related digital document previously provided by the first party,
electronically authenticates the second party, and
facilitates an electronic exchange of the second insurance-related digital document between the insurance provider and the customer via the second party customer communication medium;
transmitting, by the graphical user interface associated with the insurance provider, an access code to the third party electronic signature service server, wherein the access code is a single access code usable by all agents or representatives of the first party;
receiving, by the first party graphical user interface provider that is distinct from any third party electronic signature service applications, the second insurance-related digital document with a digital signature of the customer from the third party electronic signature service server; and
updating an insurance policy, via a processor, upon receipt of the digital signature of the customer such that remotely obtaining a digital or electronic signature of the customer on insurance-related documents and/or timely updating an insurance policy for the customer is facilitated.
